(19) United States
(12) Patent Application Publication
(10) Pub. No.: US 2004/0258305 A1
(43) Pub. Date: Dec. 23, 2004

(54) Image segmentation

(76) Inventors: Keith J. Burnham, University (GB); Olivier Haas, University (GB); Maria Gloria Bueno, Priory (GB)

Correspondence Address: Douglas N Larson, Squire Sanders & Dempsey, 14th Floor, 801 South Figueroa, Los Angeles, CA, 90017-5554, US

(21) Appl. No.: 10/482,196

(22) PCT Filed: Jun. 27, 2002
(86) PCT No.: PCT/GB02/02945

(30) Foreign Application Priority Data
Jun. 27, 2001 (GB) 0115615.7

(51) Int. Cl. G06K 9/00; G06K 9/34

(52) U.S. Cl. 382/171; 382/173; 382/131

(57) ABSTRACT

In a method of segmenting an image a first seed pixel unit is selected from a first group of pixel units in which the pixel units all have substantially the same grey-level intensity. The grey-level intensity of said first pixel unit is compared with the grey-level intensity of each of selected adjacent pixel units of said image and those pixel units with grey levels within a selected range arm assigned as a pixel unit of the same region as said first pixel unit This comparison process is repeated for each of the pixel units in the image, those already having been assigned being ignored. A further seed pixel unit is selected from a further group of pixel units in which the pixel units all have substantially the same grey-level intensity and the comparison process repeated for all of the unassigned pixel units. Further seed pixel units are selected and the comparison process repeated until all the pixel units of the image have been assigned. A watershed transform is then applied to provide the segmented image.

The present invention relates to a process for segmenting images.

There are many fields in which images such as digital images need to be processed in order to enhance the image for viewing and/or further processing. One such field is in medical imaging where, in X-ray Computed Tomography (CT) for example, the images viewed by the medical specialist need to be sufficiently clear for a proper diagnosis to be made and treatment to be given.

In Computed Tomography a computer stores a large amount of data from a selected region of the scanned object, for example, a human body, making it possible to determine the spatial relationship of radiation-absorbing structures within the scanning x-ray beam. Once an image has been acquired by scanning it is then subjected to segmentation which is a technique for delineating the various organs within the scanned area.

Segmentation can be defined as the process which partitions an input image into its relevant constituent parts or objects, using image attributes such as pixel intensity, spectral values and textural properties. The output of this process is an image represented in terms of edges, regions and their interrelationships. Segmentation is a key step in image processing and analysis, but it is one of the most difficult and intricate tasks. Many methods have been proposed to overcome image segmentation problems, but all of them are application dependent and problem specific.

The general objective of segmentation of medical images is to find regions which represent single anatomical structures. This makes feasible tasks such as interactive visualisation and automatic measurement of clinical parameters. Medical segmentation is becoming an increasingly important step for a number of clinical investigations, these include:

a) Identifying anatomical areas of interest for diagnosis treatment or surgery planning,

b) Pre-processing for multi-modal image registration and improved correlation of anatomical areas of interest

c) Tumour measurement for diagnosis and therapy.

Over the last decade there have been a number of advances in Radiotherapy Treatment Planning (RTP) and treatment delivery. These have resulted in the need for systems that can generate complex treatment plans that are sensitive to the patients' anatomy, (the geometrical shape and the location of the organs) for placement of the radiation beams. In such systems the complete and precise segmentation or contouring of therapy relevant structures (namely the gross tumour volume (GTV), clinical target volume (CTV) and adjacent non-target normal tissues, together termed the Planning Target Volume (PTV), is a crucial step and one major bottleneck in the whole treatment planning process. It is estimated that 66% of all tumour patients are referred to radiation therapy. About 40% of these can be treated effectively with current methods. Another 40% are not suitable for treatment because the disease has spread too far. The remaining 20% could be treated if the planning methods were generally available.

It is only by displaying the relevant structures that the clinical oncologist can devise an optimal plan that will treat the PTV to a given prescribed radiation dose while minimising radiation of non-target tissues thereby maximising the therapeutic gain of treatment. In common practice, the segmentation process is usually done manually slice by slice, and for a typical set of 40 slices, it can be a time consuming and tedious process.

The present invention seeks to provide an improved method of segmentation of an image.

Accordingly, the present invention provides a method of segmenting an image comprising:

selecting a pixel unit from a first group of pixel units in which the pixel units all have substantially the same grey-level intensity;

comparing the grey-level intensity of said first pixel unit with the grey-level intensity of each of a plurality of selected pixel units of said image;

assigning each said selected pixel unit as a pixel unit of the same region as said first pixel unit in response to the grey-level intensity of said adjacent pixel unit falling within a preselected grey-level intensity range;

selecting a further pixel unit from a further group of pixel units in which the pixel units have substantially the same grey-level intensity;

comparing the grey-level intensity of said further pixel unit with the grey-level intensity of each of a plurality of selected pixel units of said image, wherein each selected adjacent pixel unit which is already assigned as a pixel unit of a region is ignored;

assigning each unassigned said selected pixel unit as a pixel unit of the same region as said further pixel unit in response to the grey-level intensity of said selected adjacent pixel unit falling within a preselected further grey-level intensity range;

and repeating the above steps until all of the pixel units in the image have been assigned to a region

The present invention also provides a method of segmenting an image comprising the steps of:

(a) selecting a first pixel unit from a first group of pixel units in which the pixel units all have substantially the same grey-level intensity;

(b) selecting a first grey-level intensity range relative to the grey-level intensity of said first pixel unit;

(c) comparing the grey-level intensity of said first pixel unit with the grey-level intensity of each of selected adjacent pixel units of said image;

(d) assigning each said selected adjacent pixel unit as a pixel unit of the same region as said first pixel unit in response to the grey-level intensity of said adjacent pixel unit falling within said first grey-level intensity range;

(e) comparing the grey-level intensity of said first pixel unit with the grey-level intensity of each of selected next adjacent pixel units of said image;

(f) assigning each said selected next adjacent pixel unit as a pixel unit of the same region as said first pixel unit in response to the grey-level intensity of said next adjacent pixel unit falling within said first grey-level intensity range;

(g) repeating steps (e) and (f) for each of the pixel units in the image;

(h) selecting a further pixel unit from a further group of pixel units in which the pixel units have substantially the same grey-level intensity;

(i) selecting a further grey-level intensity range relative to the grey-level intensity of said further pixel unit;

(j) comparing the grey-level intensity of said further pixel unit with the grey-level intensity of each of selected adjacent pixel units of said image, wherein each selected adjacent pixel unit which is already assigned as a pixel unit of a region is ignored;

(k) assigning each unassigned said selected adjacent pixel unit as a pixel unit of the same region as said further pixel unit in response to the grey-level intensity of said selected adjacent pixel unit falling within said further grey-level intensity range;

(l) comparing the grey-level intensity of said further pixel unit with the grey-level intensity of each of selected next adjacent pixel units of said image;

(m) assigning each said unassigned selected next adjacent pixel unit as a pixel unit of the same region as said further pixel unit in response to the grey-level intensity of said selected next adjacent pixel unit falling within said further grey-level intensity range;

(n) repeating steps (l) and (m) for each of the pixel units in the image;

(O) and repeating steps (h) to (n) until all of the pixel units in the image have been assigned to a region.

Preferably, said first group of pixel units is the largest group of pixel units in the image and said further group of pixel units is the next largest group of pixel units.

The term “pixel unit” is used herein to refer to a single pixel or a group of adjacent pixels which are treated as a single pixel.

In a preferred form of the invention the method further comprises the steps of building a mosaic image, deriving the gradient of the mosaic image and applying a watershed transform to said gradient to provide said segmented image.

Advantageously, the method further comprises the step of applying a merging operation to said segmented image to reduce segmentation of the image.

Preferably, each said pixel unit is a single pixel.

The present invention is further described herein after, by way of example, with reference to the accompanying drawings, in which:

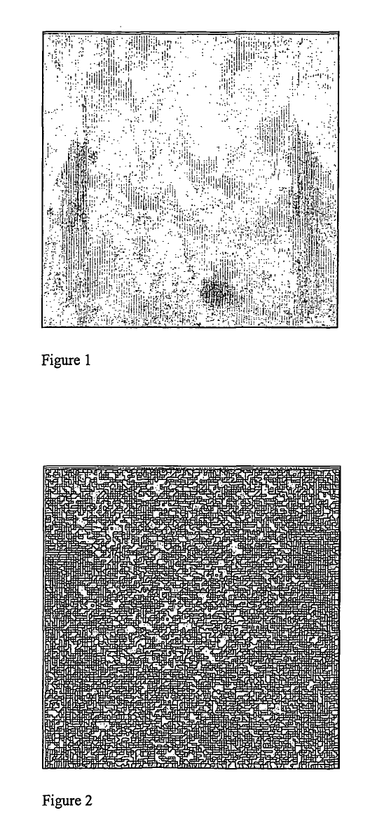

FIG. 1 is a view of an image produced by a CT scan;

FIG. 1a is a flow chart of an image processing technique according to the present invention which can be applied to the image of FIG. 1;

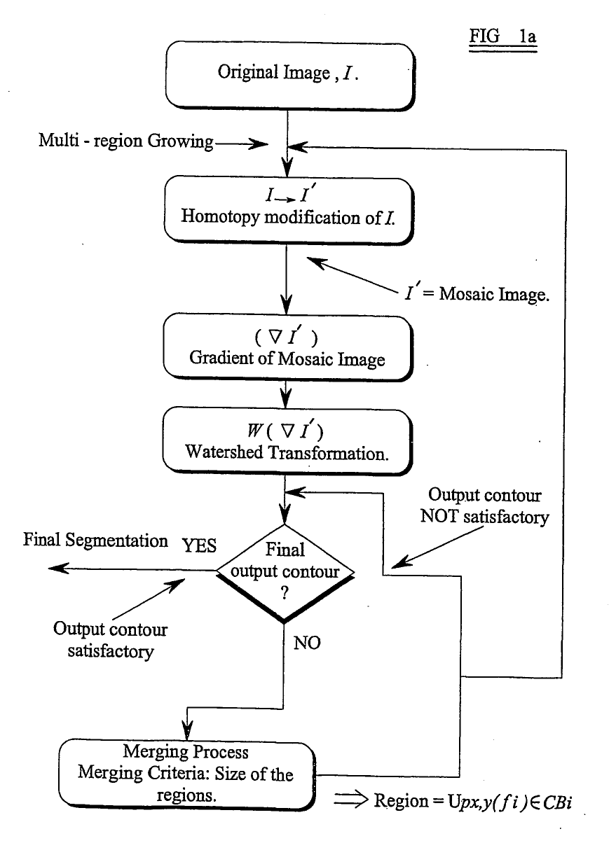

FIG. 2 is an image produced from the image of FIG. 1 by application of a Watershed transform;

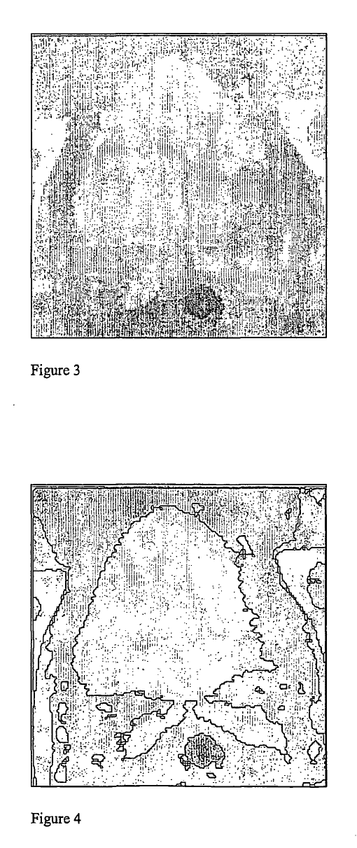

FIG. 3 is a mosaic image generated from the image of FIG. 1;

FIG. 4 is an image produced by a Watershed transformation of the image of FIG. 3;

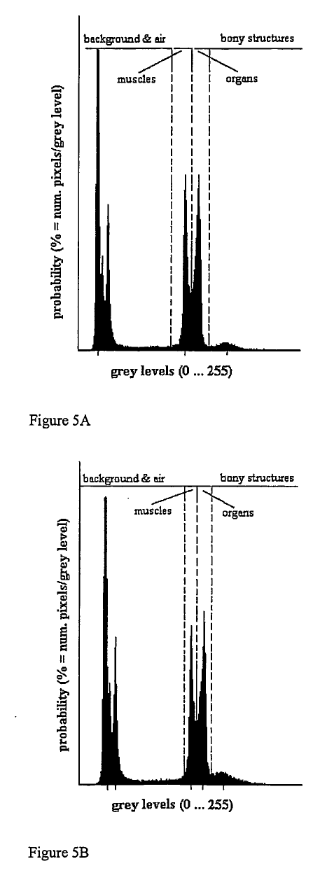

FIGS. 5A and 5B are frequency histograms of two of a set of image “slices” similar to that of FIG. 1;

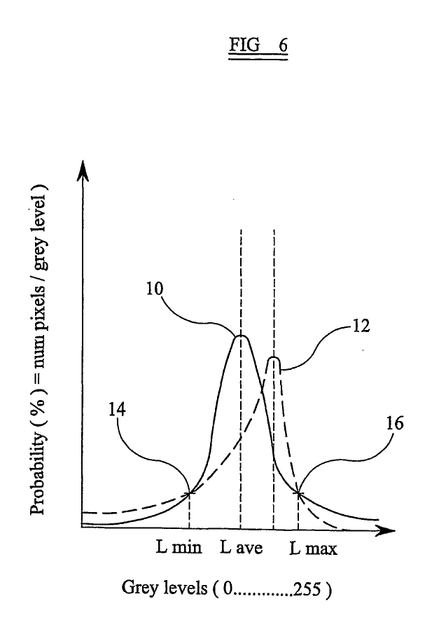

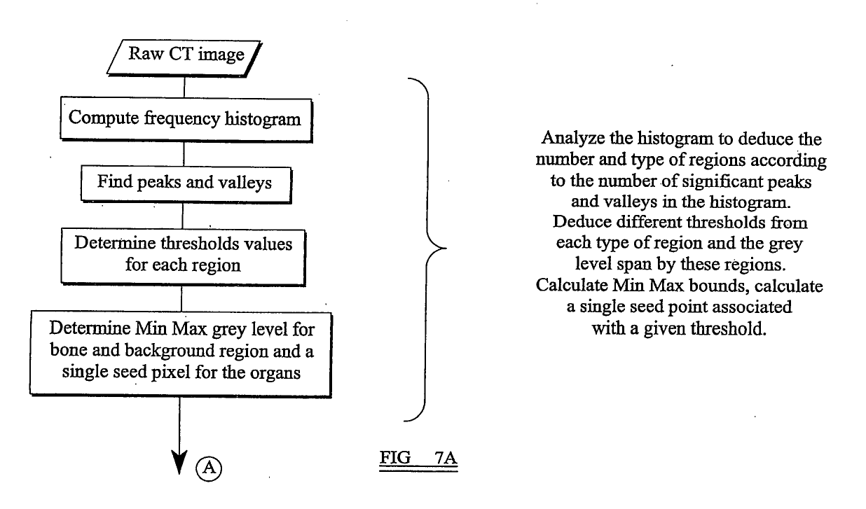

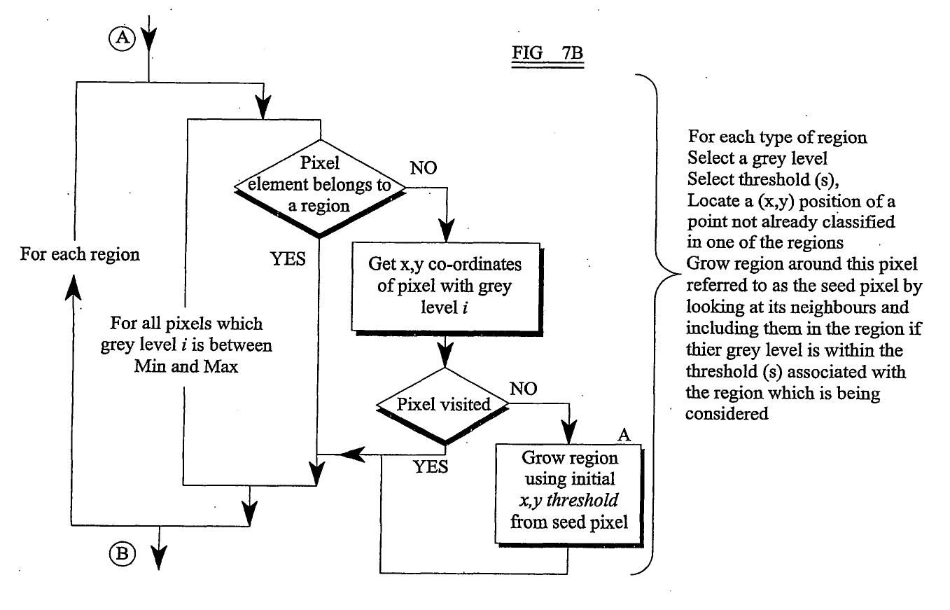

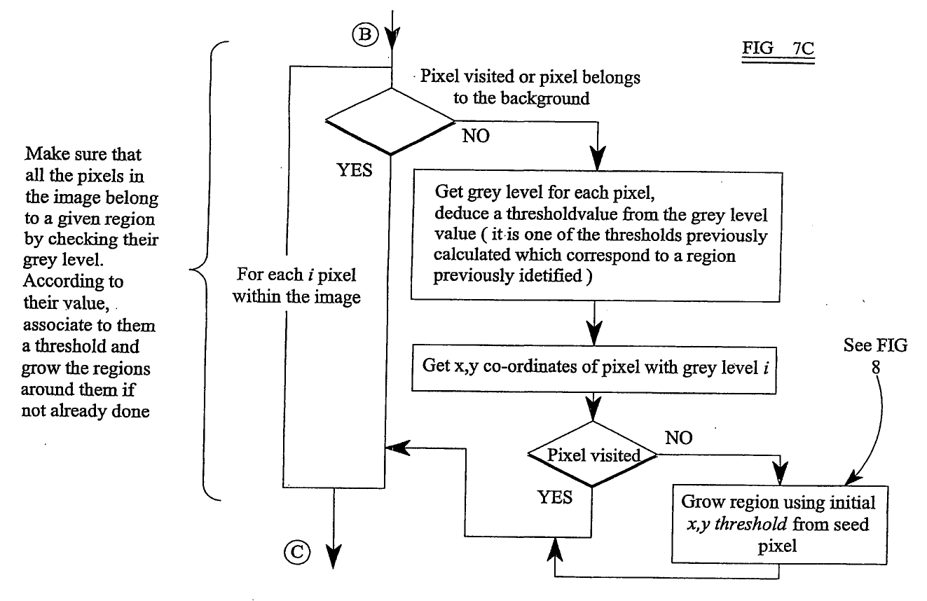

FIG. 6 is a frequency histogram showing a Gaussian distribution curve and a non Gaussian distribution curve superimposed on one another;

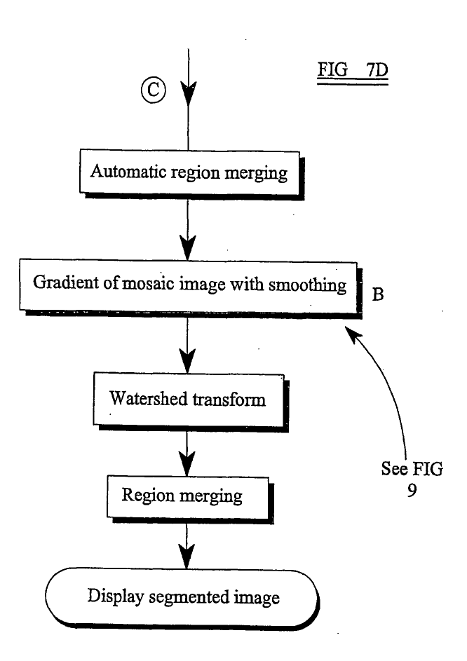

FIG. 7 is a simplified flowchart showing the process of operation of a preferred method according to the present invention;

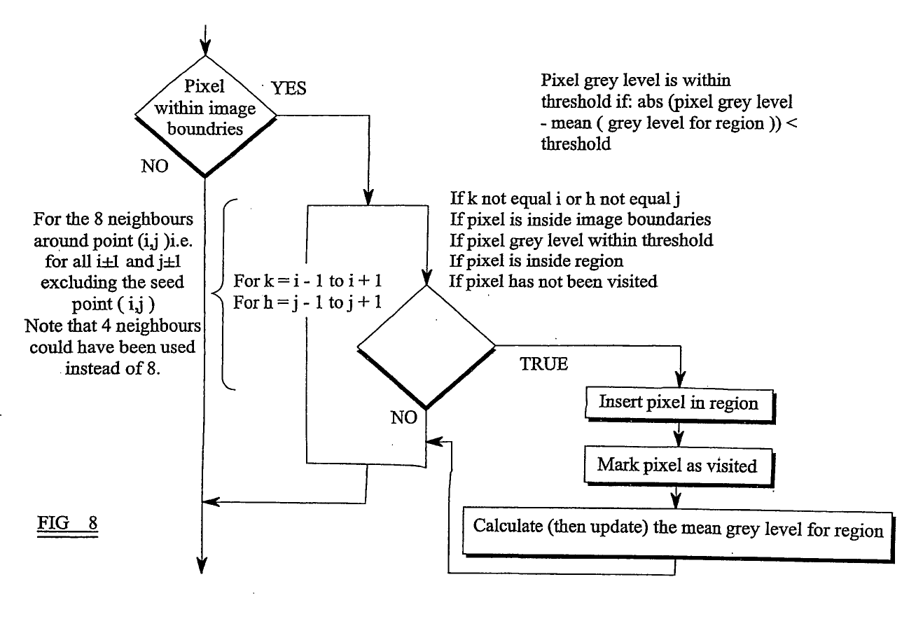

FIG. 8 is a detailed flowchart of part A of the process of FIG. 7;

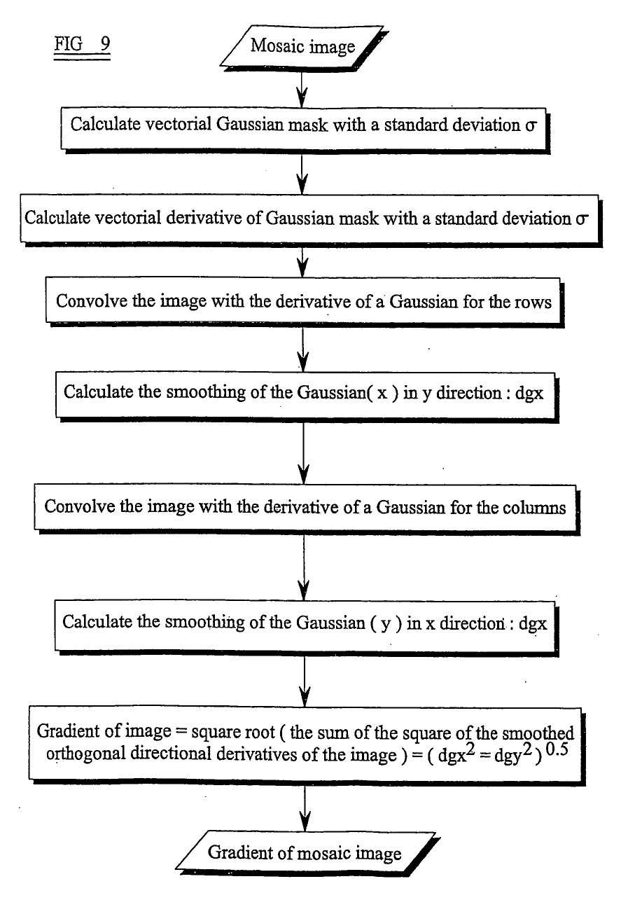

FIG. 9 is a detailed flowchart of part B of the process of FIG. 6; and

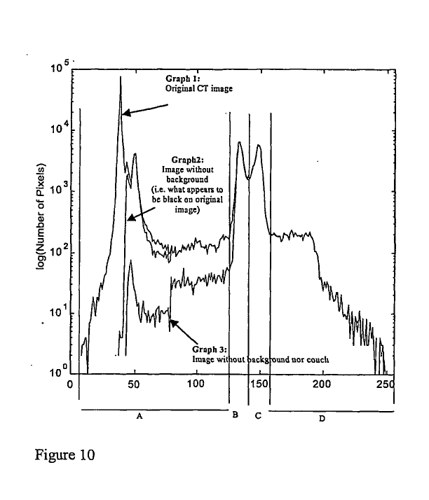

FIG. 10 is a chart of histograms illustrating the effect of a couch and background on the histogram of FIG. 9.

Referring to the drawings, FIG. 1 shows an original grey scale image which is produced by a CT scan. FIG. 1a is a flow chart of an image processing technique according to the present invention which can be applied to the image of FIG. 1. In the process, the image is transformed into a mosaic image and the gradient image obtained. Itis the magnitude of the gradient which is used in order to avoid negative peaks. A morphological gradient operator would avoid the production of negative values and produces an image which can be used directly by a Watershed transform. The Watershed transform followed by a merging process is then applied to provide the final image of FIG. 2. As can be seen, the number of discrete regions in the image of FIG. 2 is considerable and would normally be of the order of several thousands. In this particular example the number of regions is seven thousand nine hundred and sixty-eight. This image would then need to be processed manually by a skilled operator in order to produce a reasonable image for viewing by the medical practitioner (given the large number of regions this may become prohibitive in terms of time).

In order to reduce the number of regions produced by the Watershed transformation, in the preferred form of the process the original image is digitally coded and stored with each unit (byte) of the digitally stored image representing the grey scale level of a pixel of the original image.

As can be seen from FIG. 2, when attempting to segment the image of FIG. 1 the initial Watershed transform of the gradient image provides very unsatisfactory results since many apparently homogeneous regions are fragmented in small pieces. In the preferred process according to the present invention the Watershed transformation is applied to a simplified image. In the simplified image the homogeneous regions of the original image are merged, the simplified image of FIG. 3 being made of a patchwork of pieces of uniform grey-level and is referred to as a partition or mosaic image.

Although the loss of information, which occurs when the original image of FIG. 1 is transformed into the mosaic image of FIG. 3, is important, the main contours of the initial image of FIG. 1 are preserved. In such a simplified image, regions with identical grey levels may include actually different structures due to overgrowing. To solve this problem the simplified image is further transformed.

To begin the process, the pixels of the image are stored in a temporary list (the boundary list) of pixels which are to be analysed. This list contains spatial information (x and y co-ordinates) and the intensity value of the pixels (grey-level).

In order to calculate the mosaic image of FIG. 3 a multi-region growing algorithm is used. This starts with a seed pixel which can be provided by the user who selects a seed point in the original image of FIG. 1. This has previously been effected manually, for example by using a pointing device such as a mouse. The seed point chosen would normally be inside a region of interest in the image.

In order to carry out this process automatically, a frequency histogram of the grey-levels of the original image is first of all determined. In this way, each grey-level is referenced to each pixel within the original image which belongs to that particular level. FIGS. 5A and 5B show a histograms of two image slices similar to that of FIG. 1 in which it can be seen that various parts of the body such as muscles, organs and bone structures are characterised by or exhibit different grey-levels and therefore different distributions in the histogram.

A predetermined grey-level in each distribution is taken as corresponding to the intensity value of a representative pixel of the region which is represented by that distribution. The pixels of each distribution which form the representative pixels are selected as the seed pixels for each growing operation. By automatically selecting these seed pixels from the histogram a step of manually pointing at the image to specify the location of the seed pixels is avoided.

Each distribution of the histogram maybe a Gaussian or non Gaussian distribution and FIG. 6 shows a diagrammatic representation of two distribution curves 10, 12 of a frequency histogram. The curves represent two different regions of the histogram but are superimposed on one another to illustrate the differences between a Gaussian and a non Gaussian distribution. Curve 10 shows a Gaussian distribution with the threshold minimum and maximum grey levels for the region represented by the curve 10 being chosen at Lₘᵢₙ and Lₘₐₓ (points 14 and 16 on the curves). Curve 12 shows a non Gaussian distribution superimposed on curve 10 with the minimum and maximum grey levels for the region represented by the curve also being chosen at Lₘᵢₙ and Lₘₐₓ. In practice, because the curve 12 would be in a different pail of the histogram the threshold grey levels would be different values, but they are shown here having the same values for ease of explanation.

In the preferred method, the predetermined grey level used to define the representative pixel (seed pixel) for each region is the average grey level in each distribution.

Where a Gaussian distribution of the grey levels in a region occurs or is assumed (curve 10), since the threshold grey levels for the region are equidistant from the distribution peak, the average grey level in the distribution is equal to the grey level corresponding to the peak of the distribution and is Lₐᵥₑ=(Lₘᵢₙ+Lₘₐₓ)/2.

Where, however, a non-Gaussian distribution of the grey levels in a region occurs, the average grey level in the distribution will not be equal to the peak of the distribution (curve 12).

It will be appreciated that in such non-Gaussian distribution the predetermined grey level used to define the representative pixel (seed pixel) for each region could be the average grey level, the grey level corresponding to the peak of the distribution or the grey level corresponding to the central position between the thresholds Lₘᵢₙ and Lₘₐₓ.

Once the histogram has been created the grey level values of the pixels are sorted according to frequency in descending order, ie the pixels having an intensity value which occurs most frequently are placed first in the sorting order. The effect of this is that the representative pixels will occur at the beginning of the ordered boundary list. It will be appreciated, therefore, that the region that occupies the largest portion of the image is grown first, the region occupying the second largest portion is grown second and so on.

The growing process for the first region begins with the first pixel at the head of the ordered boundary list.

The first pixel in the list is scanned in order to determine whether or not the grey-level of the pixel lies within a certain intensity range. If the scanned pixel meets the requirement it is transferred to a further store in anew list (the region list). If the pixel does not meet the requirement then it is ignored.

If the scanned pixel meets the requirement then the eight immediately adjacent, surrounding pixels (which may or may not belong to distributions other than the one currently being created) of the image are tested to determine if they also meet the requirement and can therefore be included in the region being grown. If a neighbour pixel being tested has already been assigned to a region then it is ignored. If the neighbour pixel has not already been assigned to a region and passes a statistical test for homogeneity criteria (ie if the pixel grey-level lies within a certain intensity range) itis inserted in the region list and its identifier value in the original image is changed to the region value. This procedure is repeated until all the pixels in the image belong to one of the regions. It will be appreciated that whilst the scanning refers to eight adjacent pixels, the scan maybe effected using other connectivities e.g. four or six.

The following test is used as a basis for including a pixel in a region and applies for Gaussian distributions. It also applies for non Gaussian distributions where the average grey level intensity Lₐᵥₑ is used to determine the seed pixel.

Here a pixel p_{x,y} of intensity L_{(x,y)} is included in the region list if it passes the similarity criteria, i.e., if the following condition is satisfied:

|Lₐᵥₑ−L_{(x,y)}|≦T_{w}

where Lₐᵥₑ is the average grey intensity level and T_{w} is a threshold “window” control parameter. In the case of curve 10 (Gaussian) of FIG. 6, Lₐᵥₑ is equal to the peak value grey level and is midway between Lₘₐₓ and Lₘᵢₙ. Thus T_{w} is equal to (Lₘₐₓ−Lₘᵢₙ)/2. The parameter Lₐᵥₑ acts as a central value for growing the region, and the parameter T_{w} acts as a threshholding distance in pixel intensity units from the central value.

In a non Gaussian distribution where the average grey level intensity Lₐᵥₑ is not equal to the peak value grey level and therefore is not midway between Lₘₐₓ and Lₘᵢₙ, two thresholds T_{w1} and T_{w2} are needed, where:

T_{w1}+T_{w2}=Lₘₐₓ−Lₘᵢₙ

Thus:

L_{(xy)}−Lₐᵥₑ≦T_{w1} for L_{(xy)}>Lₐᵥₑ

Lₐᵥₑ−L_{(xy)}≦T_{w2} for L_{(xy)}<Lₐᵥₑ

Before region growing is started, the values of the level parameter Lₐᵥₑ and window control parameter T_{w} must be set appropriately. The value of Lₐᵥₑ maybe set to the intensity value of the seed pixel, which in turn represents the central value of the region to be grown. Alternatively, it may be obtained from a previous processing step, which includes a statistical analysis of pixels around the region of interest. In this case Lₐᵥₑ can be set equal to the mean of the sample region. Usually, a 20×20 pixel matrix is taken for the sample, but larger samples introduce a degree of data smoothing and may give more accurate calculation of the region statistics. However, if the sample area is too large then the computational time can become too long.

The values of the parameter T_{w} can be set interactively or automatically.

To set the value of T_{w} interactively the user can specify the value in a window which forms part of the GUI (graphical user interface) control panel for the algorithm.

A range of results can be quickly observed simply by setting the threshold value T_{w} at different levels in order to extract different regions from the original image. As will be appreciated, if the seed pixel remains the same, a higher value for the threshold T_{w} will normally result in large regions being grown. Changing the seed pixel for the same threshold value T_{w} will also produce a different grown region pattern.

If the same value is used for the threshold value parameter T_{w} then the process produces good results with high contrasting objects within the image, such as pelvic bones and body contour. However, this is not the case when segmenting soft tissues such as the bladder and seminal vesicles where the contrasts are relatively low between objects. Using a high threshold value T_{w} results in a relatively small number of regions being produced (typically several hundred) which results in a loss of structures. With a high value of T_{w} it is possible to obtain segmentation of just the bones and the body contour.

If a low threshold value T_{w} is used this results in over segmentation with a relatively large number of regions (typically several thousand) being produced.

The results are therefore dependent on the threshold value T_{w} and therefore in the growing process an adaptive threshold value T_{w} is applied to each region instead of a single threshold value T_{w} for the whole image.

To set the threshold value T_{w} automatically, it can be computed by the region growing algorithm which examines the statistics of the pixels within a sample region R of about 20 pixels in size (the figure of 20 may, of course, be varied as required). This sample region R is located centrally over the seed point of the region. The window threshold parameter T_{w} is computed by multiplying the standard deviation of the sample region with a scaling factor K which is dependent on the signal to noise ratio in the image. A scaling factor K of value of 2.0 has been found to give reasonable results for CT and Magnetic Resonance (MR) images.

The threshold value T_{w} for each region is calculated automatically by taking into account the histogram information. The threshold value T_{w} for each region is calculated prior to and independently of the growing process and is effected firstly by looking for sequences of pixels in the histogram that follow a “peak like” pattern. To avoid identifying false peals because of noise, the process ignores peaks which have a pixel width less than a preselected number, typically seven pixels. If the grey-level spacing between adjacent peaks is relatively large then the threshold value T_{w} for the region being grown can also be large. Where the adjacent peaks are close together on the grey-level scale then the threshold value T_{w} will need to be relatively small.

The segmented image may still contain some false regions that are produced as a result of CT artifacts. These are undesired regions which are not wanted by the clinicians and are removed through a merging process.

The merging process looks at adjacent legions and will merge a first region into an adjacent second region if the number of elements of the first region are:

(a) considerably fewer (by a preselected amount) than the number of elements of the second region, and

(b) less than a threshold number E which represents a minimum number of elements in a region above which a merge is not allowed.

An element is a preselected area of a region and is typically a single pixel.

When the first region is merged into the second region the intensity level of each of the pixels is adjusted to that of the pixels of the second region.

The resulting image is the mosaic image shown in FIG. 3. It is a simplified image made of a mosaic of homogeneous pieces of constant grey-levels and is a homotopy modification of the original image.

The boundaries of the grey scale areas in the image are differentiated to provide boundary ridges to which a Watershed transform cal be applied.

If one uses a Watershed transform on the gradient image the number of Watershed lines and the computational process in terms of time and memory requirements are optimised.

The above process can be applied in different domains without previous knowledge of the regions of interest within the original image. The preferred method is based on homotopy modification of the original image prior to applying the Watershed transformation. The homotopy modification of the original image produces a mosaic image.

Using the above process over-segmentation is considerably reduced and satisfactory results in terms of accuracy, computational time and memory are obtained.

FIG. 7 illustrates a flow chart showing the steps which are carried out in order to obtain the image of FIG. 4. FIG. 8 is a flow chart showing in more detail the steps for region growing of FIG. 7 and FIG. 9 shows in more detail the steps for obtaining the gradient of the mosaic image of FIG. 3 with Gaussian smoothing. It will be appreciated that other ways of obtaining the gradient used by the Watershed transform can be used, for example, morphological gradient/operators.

Analysing Histograms

The technique of analysing histograms aims to determine a seed pixel and a threshold.

FIG. 10 shows three different histograms 20, 22 and 24 similar to those of FIGS. 5A and 5B of a pelvic CT image. Graph 20 is from the original CT image, graph 22 is graph 20 with the couch removed and graph 24 is graph 20 without the couch and background.

Referring to graph 20, this contains four distinct peaks 30, 32, 34 and 36. These have been found automatically using relational operators to define peaks in the histogram and a minimum height to allow small peaks to be disregarded. The first peak 30 is by far the largest, typically being composed of about half of all the image pixels. It is located at the low intensity end of the histogram and analysis of the image shows that this represents mainly air with some background counts.

The second peal (32, very close to the first, is much smaller, with only about 1.5% of pixels at the peak grey-level. This represents much of the image of the couch on which the patient lies, although this will vary between couches.

The final two peaks 34, 36 are located further along the histogram and very close together. This indicates a degree of overlap in intensities between regions. These are separated by finding the local minimum between the peaks using a similar method to that used to find peaks automatically. The darker peak 34 represents fat and soft tissue. The brighter peak 36 represents muscle and organs. These pixels include the bladder and prostate.

Note that the bones and rectum region which include a wide range of grey-level are not represented by peaks but by valleys or plateau. The interior of the rectum is located at the grey-levels between peaks 32 and 34 as depicted in the top left image in Figure 10. Finally the bones can be found at grey-levels above the fourth peak 36.

It has been observed that the removal of the couch from the CT by pre-processing or the removal of the background can affect the histogram, indeed the first two peaks 30, 32 may disappear as shown in graph 24. Note that the number of pixels in the region A between 0 and 120 is much reduced compared to graph 22.

The threshold and seed points for various parts of the histograms are set out below.

rectum

The threshold value T_{w}=(L_{max-A}−L_{min-A})/2

The seed point=(L_{max-A}+L_{min-A)/}2

bones

The threshold value T_{w}=(L_{max-D}−L_{min-D})/2

The seed point=(L_{max-D}+L_{min-D})/2

OAR type 1

The threshold value T_{w}=(L_{max-B}−L_{min-B})/2

The seed point=(L_{max-B}+L_{min-B})/2

OAR type 2

The threshold value T_{w}=(L_{max-C}−L_{min-C})/2

The seed point=(L_{max-C}+L_{min-C})/2

To overcome this loss of information in the histogram, the original code was modified such that the rectum can be identified from the sharp cut-oft below which no pixels are found. This cut-off grey-level has been used to define the start of the lowest threshold region in a modified image.

The result of applying the multi-region growing gives us a simplified image made of a mosaic of homogeneous pieces of constant grey-levels (mean grey-level of the growth region) with the same properties as the mosaic image. This produces a homotopy modification of the original image and consequently of the gradient image. Using the watershed transform in this simplified image the number of watershed lines and the computational process in terms of time and memory requirements are optimised. Compared to a standard, multithresholding region growing process without mosaic image, the method of the present invention produces a segmented image with less overgrowing of regions while reducing the number of regions which would be produced by watershed alone.

It will be appreciated that the invention has application outside of the medical field, such as military applications, robotics or any application which involves pattern recognition schemes.

1. A method of segmenting an image comprising:
(a) selecting a first pixel unit from a first group of pixel units in which the pixel units all have substantially the same grey-level intensity;
(b) selecting a first grey-level intensity range relative to the grey-level intensity of said first pixel unit;
(c) comparing the grey-level intensity of said first pixel unit with the grey-level intensity of each of selected adjacent pixel units of said image;
(d) assigning each said selected adjacent pixel unit as a pixel unit of the same region as said first pixel unit in response to the grey-level intensity of said adjacent pixel unit falling within said first grey-level intensity range;
(e) comparing the grey-level intensity of said first pixel unit with the grey-level intensity of each of selected next adjacent pixel units of said image;
(f) assigning each said selected next adjacent pixel unit as a pixel unit of the same region as said first pixel unit in response to the grey-level intensity of said next adjacent pixel unit falling within said first grey-level intensity range;
(g) repeating steps (e) and (f) for each of the pixel units in the image;
(h) selecting a further pixel unit from a further group of pixel units in which the pixel units have substantially the same grey-level intensity;
(i) selecting a further grey-level intensity range relative to the grey-level intensity of said further pixel unit;
(j) comparing the grey-level intensity of said further pixel unit with the grey-level intensity of each of selected adjacent pixel units of said image, wherein each selected adjacent pixel unit which is already assigned as a pixel unit of a region is ignored;
(k) assigning each unassigned said selected adjacent pixel unit as a pixel unit of the same region as said further pixel unit in response to the grey-level intensity of said selected adjacent pixel unit falling within said further grey-level intensity range;
(l) comparing the grey-level intensity of said further pixel unit with the grey-level intensity of each of selected next adjacent pixel units of said image;
(m) assigning each said unassigned selected next adjacent pixel unit as a pixel unit of the same region as said further pixel unit in response to the grey-level intensity of said selected next adjacent pixel unit falling within said further grey-level intensity range;
(n) repeating steps (l) and (m) for each of the pixel units in the image;
(O) and repeating steps (h) to (n) until all of the pixel units in the image have been assigned to a region.

2. A method as claimed in claim 1 wherein:
said first group of pixel units is the largest group of pixel units in the image;
and said further group of pixel units is the next largest group of pixel units.

3. A method as claimed in claim 1 further comprising the steps of:
(p) building a mosaic image;
(q) deriving the gradient of the mosaic image; and
(r) applying a watershed transform to said gradient to provide said segmented image.

4. A method as claimed in claim 3 further comprising the step of applying a merging operation to said segmented image to reduce segmentation of the image.

5. A method as claimed in claim 4 wherein a region is merged into an adjacent region if the number of pixel units in said region is less than a preselected number.

6. A method as claimed in claim 1 wherein each said pixel unit is a single pixel.

7. A method as claimed in claim 1 wherein the step of selecting said first and further pixel units comprises creating a frequency histogram of the grey level values of said image and selecting a predetermined grey level value in each distribution of said histogram to define said first and further pixel units.

8. A method as claimed in claim 7 wherein the predetermined grey level value for said first pixel unit is chosen from the largest distribution in the histogram, and for each successive further pixel unit is chosen from the next successive largest distribution in the histogram.

9. A method as claimed in claim 7 wherein said predetermined grey level is the average grey level of the distribution.

10. A method as claimed claim 1 wherein the distribution is a Gaussian distribution and each adjacent pixel unit is assigned to a region when the following condition is met:

|Lₐᵥₑ−L_{(x,y)}|≦T_{w}
where:
Lₐᵥₑ=the average grey level intensity of the distribution;
L_{(x,y)}=the grey level intensity of the selected pixel unit in the distribution; and
T_{w}=a preselected threshold parameter value in the distribution.

11. A method as claimed in claim 10 wherein Lave is the peak value grey level and T_{w}=(Lₘₐₓ−Lₘᵢₙ)/2, where Lₘₐₓ and Lₘᵢₙ are preselected upper and lower grey level values for the distribution.

12. A method as claimed in claim 1 wherein the distribution is a non Gaussian distribution and each adjacent pixel unit is assigned to a region when the following conditions are met:
L_{(xy)}−Lₐᵥₑ≦T_{w1} for L_{(xy)}>Lₐᵥₑ
Lₐᵥₑ−L_{(xy)}≦T_{w2} for L_{(xy)}<Lₐᵥₑ
where:
Lₐᵥₑ=a preselected grey level intensity within the distribution;
L_{(x,y)}=the grey level intensity of the selected pixel unit;
T_{w1}=a preselected lower threshold parameter value in the distribution; and
T_{w2}=an upper preselected threshold parameter value in the distribution.

13. A method as claimed in claim 12 wherein the value of Lₐᵥₑ is obtained from a statistical analysis of at least a portion of the distribution.

14. A method as claimed in claim 13 wherein value of Lₐᵥₑ is equal to the mean of a selected sample region within the distribution.

15. A method as claimed in claim 13 wherein said selected sample region comprises a 20×20 pixel matrix.

16. A method of segmenting an image comprising:
selecting a pixel unit from a first group of pixel units in which the pixel units all have substantially the same grey-level intensity;
comparing the grey-level intensity of said first pixel unit with the grey-level intensity of each of a plurality of selected pixel units of said image;
assigning each said selected pixel unit as a pixel unit of the same region as said first pixel unit in response to the grey-level intensity of said adjacent pixel unit falling within a preselected grey-level intensity range;
selecting a further pixel unit from a further group of pixel units in which the pixel units have substantially the same grey-level intensity;
comparing the grey-level intensity of said further pixel unit with the grey-level intensity of each of a plurality of selected pixel units of said image, wherein each selected adjacent pixel unit which is already assigned as a pixel unit of a region is ignored;
assigning each unassigned said selected pixel unit as a pixel unit of the same region as said further pixel unit in response to the grey-level intensity of said selected adjacent pixel unit falling within a preselected further grey-level intensity range;
and repeating the above steps until all of the pixel units in the image have been assigned to a region.
